(19) United States
(12) Patent Application Publication
(10) Pub. No.: US 2004/0135785 A1
(43) Pub. Date: Jul. 15, 2004

(54) Data processing path selection method and graphics processing system utilizing the same

(76) Inventors: Chi-Yang Lin, Taipei (TW); Eric Chuang, Taipei (TW); Macalas Yen, Taipei (TW)

Correspondence Address: MADSON & METCALF, GATEWAY TOWER WEST, SUITE 900, 15 WEST SOUTH TEMPLE, SALT LAKE CITY, UT, 84101

(21) Appl. No.: 10/691,685

(22) Filed: Oct. 23, 2003

(30) Foreign Application Priority Data
Jan. 15, 2003 (TW) 092100794

(51) Int. Cl. G06T 1/00; G06F 15/00

(52) U.S. Cl. 345/501

(57) ABSTRACT

A digital data processing system includes a central processing unit and a graphics processor, and the graphics processor includes a transformation/lighting engine. When graphics data, e.g. vertex data, are received, a utilization rate of the central processing unit is detected. Afterward, the graphics data are allocated to either the central processing unit or the transformation/lighting engine of the graphics processor according to the utilization rate of the central processing unit.

### FIELD OF THE INVENTION

The present invention relates to a data processing path selection method, and more particularly to a data processing path selection method for use in a digital data processing system. The present invention also relates to a graphics processing system utilizing the data processing path selection method.

### BACKGROUND OF THE INVENTION

In a functional block diagram illustrating the processing procedures of 3D graphics data as shown in FIG. 1, vertex data generated by an application program AP are processed by a vertex processing operation P1 to realize corresponding coordinates projecting on a screen space and shading effects. The information associated with the coordinates and the shading effects are further processed by a rendering operation P2.

The vertex processing operation P1 is done by performing transformation and lighting procedures for realizing corresponding coordinates projecting on a screen space and shading effects, respectively. In an early stage, the transformation/lighting procedures were implemented by a central processing unit (CPU) 21, and the rendering operation was then implemented by a graphics processor 22, as shown in FIG. 2(a). With the increasing demand on processing speed of 3D graphics, the transformation/lighting task in the current stage is transferred to a transformation/lighting engine 221, which is integrated into the graphics processor 22. Referring to FIG. 2(b), the 3D graphics processor 22 accordingly includes a transformation/lighting engine 221, and a rendering engine 222 for the transformation/lighting and the rendering operations, respectively. Also, the transformation/lighting engine 221 is defined by the Microsoft® as a vertex shader.

Since the amount of 3D graphics data to be processed becomes huger and huger than ever, the processing speed could be insufficient so as to result in data jam problem even if the graphics processor 22 is exclusively used for graphing purpose.

### SUMMARY OF THE INVENTION

It is an object of the present invention to provide a data processing path selection method a graphics processing system utilizing such method so as to enhance processing speeds of 3D graphics data.

In accordance with a first aspect of the present invention, there is provided a data processing path selection method for use in a digital data processing system. The digital data processing system comprises a central processing unit and a graphics processor, and the graphics processor comprises a transformation/lighting engine. When graphics data are received, a utilization rate of the central processing unit is detected. Afterward, the graphics data are allocated to either the central processing unit or the transformation/lighting engine of the graphics processor according to the utilization rate of the central processing unit.

In an embodiment, the graphics data are vertex data generated by an application program.

In an embodiment, the step of detecting the utilization rate of the central processing unit is performed by periodically sampling command flows of the central processing unit.

In an embodiment, the graphics data are allocated to the transformation/lighting engine of the graphics processor when the utilization rate of the central processing unit is equal to or greater than a threshold value. Otherwise, the graphics data are allocated to the central processing unit when the utilization rate of the central processing unit is less than the threshold value.

For example, the digital data processing system is a computer system.

In accordance with a second aspect of the present invention, there is provided a data processing path selection method for use in a digital data processing system. The digital data processing system comprises a central processing unit and a graphics processor, and the graphics processor comprises a transformation/lighting engine. When vertex data are received, a utilization rate of the central processing unit is detected. The vertex data are allocated to the transformation/lighting engine of the graphics processor when the utilization rate of the central processing unit is greater than a first threshold value. Otherwise, the vertex data are allocated to the central processing unit when the utilization rate of the central processing unit is less than a second threshold value.

In an embodiment, the first threshold value is identical to the second threshold value.

In accordance with a third aspect of the present invention, there is provided a graphics processing system. The graphics processing system comprises a central processing unit, a graphics processor and a path selection unit. The graphics processor comprises a transformation/lighting engine, and receives a plurality of graphics data generated by an application program. The path selection unit is electrically connected to the central processing unit and the transformation/lighting engine of the graphics processor, and allocates the graphics data to either the central processing unit or transformation/lighting engine of the graphics processor according to a utilization rate of the central processing unit.

In an embodiment, the path selection unit periodically samples command flows of the central processing unit to realize the utilization rate of the central processing unit.

In an embodiment, the path selection unit allocates the graphics data to the transformation/lighting engine of the graphics processor when the utilization rate of the central processing unit is equal to or greater than a threshold value, and allocates the graphics data to the central processing unit when the utilization rate of the central processing unit is less than the threshold value.

In an embodiment, the path selection unit is incorporated in a north bridge chip.

In an embodiment, the path selection unit is implemented by hardware.

In an embodiment, the path selection unit is implemented by firmware.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a functional block diagram illustrating the processing procedures of 3D graphics data in a computer system;

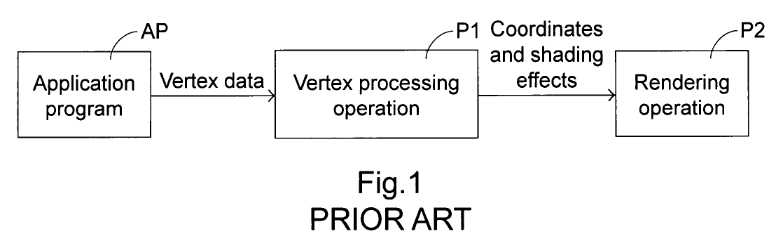

FIG. 2(a) is a block diagram schematically showing the configuration of a conventional 3D graphics processing system;

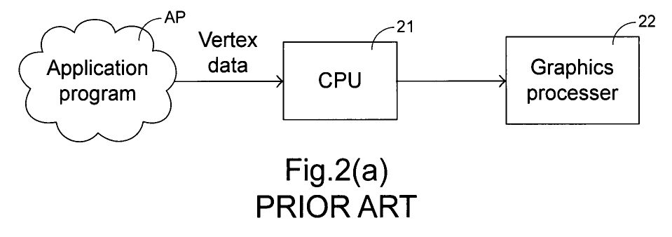

FIG. 2(b) is a block diagram schematically showing the configuration of another conventional 3D graphics processing system;

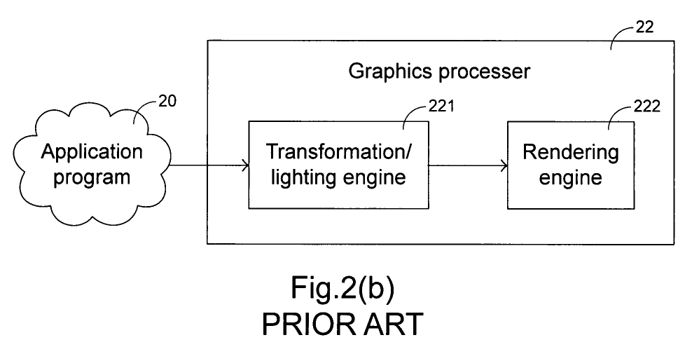

FIG. 3 is a block diagram schematically showing a 3D graphics processing system according to the present invention;

FIG. 4(a) is a block diagram exemplifying a configuration of the 3D graphics processing system according to the present invention; and

FIG. 4(b) is a block diagram exemplifying another configuration of the 3D graphics processing system according to the present invention.

### DETAILED DESCRIPTION OF THE PREFERRED EMBODIMENT

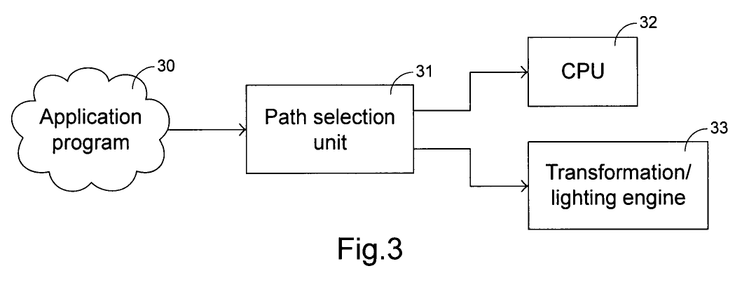

As is understood, both the CPU and the transformation/lighting engine can be used to process the vertex data. In the prior art, however, only one of them is used to perform the transformation/lighting operation. Therefore, the present invention makes use of both of the devices to improve the processing efficiency. In order to achieve this purpose, a path selection unit is provided to coordinate the use of these devices. Referring to FIG. 3, a 3D graphics processing system according to the present invention principally comprises a path selection unit 31, a central processing unit (CPU) 32 and a transformation/lighting engine 33. The path selection unit 31 is in communication with the central processing unit 32 and the transformation/lighting engine 33. The vertex data generated by an application program AP is transmitted to the path selection unit 31. The path selection unit 31 periodically samples command flows of the central processing unit 32 to realize the utilization rate of the central processing unit 32. According to the utilization rate of the central processing unit 32, the vertex data are allocated to either the central processing unit 32 or the transformation/lighting engine 33.

For example, when the utilization rate of the central processing unit 32 is equal to or greater than a threshold value, it means that the central processing unit 32 is not in an idle state. In the meantime, the path selection unit 31 allocates the vertex data to the transformation/lighting engine 33. Whereas, when the utilization rate of the central processing unit 32 is less than the threshold value, it means the central processing unit 32 is in an idle state. Accordingly, the vertex data is allocated to the central processing unit 32. Of course, the threshold value can be preset according to practical requirements. For example, the vertex data are allocated to the transformation/lighting engine 33 when the utilization rate of the central processing unit 32 is greater than a first threshold value, but allocated to the central processing unit 32 when the utilization rate of the central processing unit 32 is less than a second threshold value. By the control of the path selection unit 31, the transformation and lighting procedures can be performed in parallel by the central processing unit 32 and the transformation/lighting engine 33.

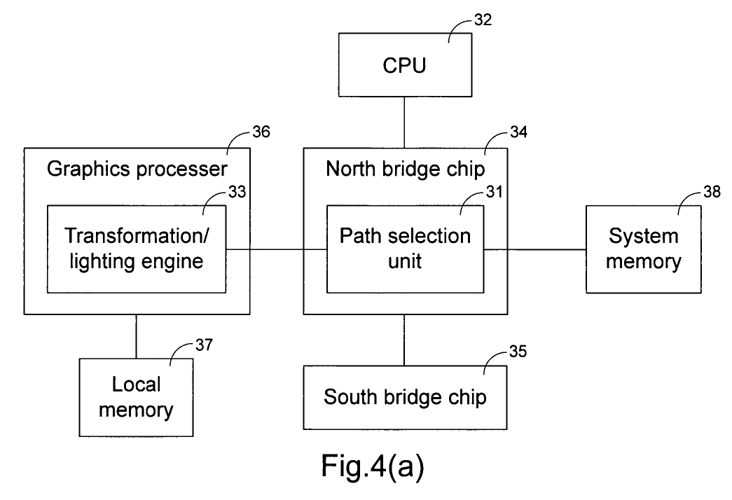

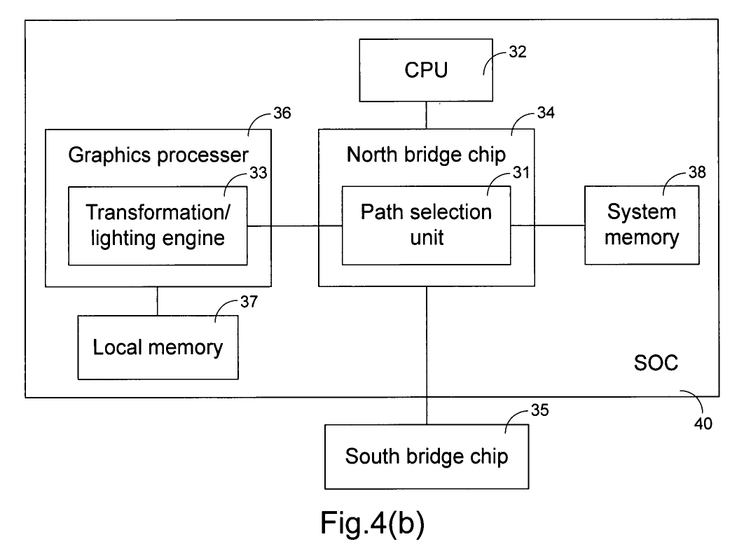

The 3D graphics processing system according to the present invention can be applied to a computer system in various forms. FIGS. 4(a) and 4(b) show two examples of the arrangement of the 3D graphics processing system according to the present invention. As shown, the path selection unit 31 is built in the north bridge chip 34 by means of hardware or firmware, and communicates with the transformation/lighting engine 33 in the graphics processor 36 and the CPU 32 via the north bridge chip 34. Accordingly, two data processing paths, i.e. one to the CPU 32 and the other to the transformation/lighting engine 33 in the graphics processor 36 are formed. Under the coordination of the path selection unit 31, the vertex data generated by the application program AP and stored in the system memory 38 can be selectively sent to one of the data processing paths, which has higher processing efficiency. Thereby, the overall processing efficiency can be enhanced.

In the computer system of FIG. 4(a), the central processing unit 32, north bridge chip 34, south bridge chip 35, graphics processor 36, local memory 37 and system memory 38 are formed as independent chips. The data transmission among these independent chips is generally conducted via buses. In order to exempt from the relatively slow bus transmission, a so-called system on chip (SOC) architecture is applied hereto. As shown in FIG. 4(b), the central processing unit 32, the north bridge chip 34, the graphics processor 36, the local memory 37 and the system memory 38 are integrated into the same chip 40 as a system on chip. With such configuration, the associated units communicate with one another via internal lines instead of buses so as to further enhance the processing speed of 3D graphics data.

Although the amount of 3D graphics data to be processed becomes huger and huger than ever, the data jam problem can be overcome by the 3D graphics processing system according to the present invention without extra hardware cost. The present invention is illustrated hereinbefore by referring to a computer system. Nevertheless, the present invention can be applied to other digital data processing system such as a video game system.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A data processing path selection method for use in a digital data processing system, said digital data processing system comprising a central processing unit and a graphics processor, said graphics processor comprising a transformation/lighting engine, said method comprising steps of:
receiving graphics data;
detecting a utilization rate of said central processing unit; and
allocating said graphics data to either said central processing unit or said transformation/lighting engine of said graphics processor according to said utilization rate of said central processing unit.

2. The data processing path selection method according to claim 1 wherein said graphics data are vertex data generated by an application program.

3. The data processing path selection method according to claim 1 wherein said step of detecting said utilization rate of said central processing unit is performed by periodically sampling command flows of said central processing unit.

4. The data processing path selection method according to claim 1 wherein said step of allocating said graphics data to either said central processing unit or said transformation/lighting engine of said graphics processor is performed by the following sub-steps:
allocating said graphics data to said transformation/lighting engine of said graphics processor when said utilization rate of said central processing unit is equal to or greater than a threshold value; and
allocating said graphics data to said central processing unit when said utilization rate of said central processing unit is less than said threshold value.

5. The data processing path selection method according to claim 1 wherein said digital data processing system is a computer system.

6. A data processing path selection method for use in a digital data processing system, said digital data processing system comprising a central processing unit and a graphics processor, said graphics processor comprising a transformation/lighting engine, said method comprising steps of:
receiving vertex data;
detecting a utilization rate of said central processing unit;
allocating said vertex data to said transformation/lighting engine of said graphics processor when said utilization rate of said central processing unit is greater than a first threshold value; and
allocating said vertex data to said central processing unit when said utilization rate of said central processing unit is less than a second threshold value.

7. The data processing path selection method according to claim 6 wherein said vertex data are generated by an application program.

8. The data processing path selection method according to claim 6 wherein said first threshold value is identical to said second threshold value.

9. The data processing path selection method according to claim 6 wherein said step of detecting said utilization rate of said central processing unit is performed by periodically sampling command flows of said central processing unit.

10. The data processing path selection method according to claim 6 wherein said digital data processing system is a computer system.

11. A graphics processing system comprising;
a central processing unit;
a graphics processor comprising a transformation/lighting engine, and receiving graphics data generated by an application program; and
a path selection unit electrically connected to said central processing unit and said transformation/lighting engine of said graphics processor, and allocating said graphics data to either said central processing unit or transformation/lighting engine of said graphics processor according to a utilization rate of said central processing unit.

12. The graphics processing system according to claim 11 wherein said path selection unit periodically samples command flows of said central processing unit to realize said utilization rate of said central processing unit.

13. The graphics processing system according to claim 11 wherein said path selection unit allocates said graphics data to said transformation/lighting engine of said graphics processor when said utilization rate of said central processing unit is equal to or greater than a threshold value, and allocates said graphics data to said central processing unit when said utilization rate of said central processing unit is less than said threshold value.

14. The graphics processing system according to claim 11 wherein said path selection unit is incorporated in a north bridge chip.

15. The graphics processing system according to claim 11 wherein said path selection unit is implemented by hardware.

16. The graphics processing system according to claim 11 wherein said path selection unit is implemented by firmware.

17. The graphics processing system according to claim 11 wherein said graphics data are vertex data.
